(19) United States
(12) Patent Application Publication
(10) Pub. No.: US 2006/0198315 A1
(43) Pub. Date: Sep. 7, 2006

(54) Communication apparatus

(75) Inventors: Yasushi Sasagawa, Kawasaki (JP); Kenichi Kawarai, Kawasaki (JP); Masami Doukai, Kawasaki (JP); Kou Takatori, Kawasaki (JP)

Correspondence Address: BINGHAM MCCUTCHEN LLP, 3000 K STREET, NW, BOX IP, WASHINGTON, DC, 20007, US

(73) Assignee: FUJITSU LIMITED

(21) Appl. No.: 11/169,687

(22) Filed: Jun. 30, 2005

(30) Foreign Application Priority Data
Mar. 2, 2005 (JP) 2005-056892

(51) Int. Cl. H04J 1/16; H04L 12/56

(52) U.S. Cl. 370/244; 370/389

(57) ABSTRACT

A communication apparatus that detects a network failure by itself, without using any particular protocol to interact with other apparatuses in a multivendor virtual LAN (VLAN) environment. The communication apparatus has a group of physical link ports, including first and second ports, to provide physical link connections to an opposite apparatus. A virtual link from the first port to the second port is formed by tunneling through the opposite apparatus. A tagged packet transmission and receiving section transmits outgoing tagged packets from the first physical link port, while receiving incoming tagged packets arriving at the second physical link port. A failure detection section detects a failure on the VLAN by checking whether every tagged packet sent out of the first port can return to the second port via the virtual link that tunnels through the opposite apparatus.

### CROSS-REFERENCE TO RELATED APPLICATIONS

This application is based upon and claims the benefits of priority from the prior Japanese Patent Application No. 2005-056892, filed on Mar. 2, 2005, the entire contents of which are incorporated herein by reference.

### BACKGROUND OF THE INVENTION

1. Field of the Invention

The present invention relates to communication apparatuses, and particularly to a communication apparatus which detects a failure on a network.

2. Description of the Related Art

Wide-area Ethernets (Ethernet is a registered trademark) have been spread recently as carrier services which use local area networks (LANs), provided by communication business parties. In the wide-area Ethernets, a plurality of Ethernet LAN environments is integrated by connecting networks with the use of layer-2 switches.

Since inexpensive switching hubs (layer-2 switches) are used in the wide-area Ethernets instead of expensive routers (layer-3 switches), network configuration cost and operation and management cost can be reduced, and it is possible, for example, that company LANs are connected to cover the whole city area.

If a network failure occurs in such a carrier network and a recovery delays, severe damage arises. To prevent this, redundant structures are employed at various levels, such as various dual packages in an apparatus, a dual apparatus, a dual link, and a dual path between ends. If a failure is detected, prompt switching to a redundant system is performed to improve failure resistance.

Even when many redundant structures are used, they are meaningless unless the apparatus can detect a failure quickly and correctly. If a silent failure (failure where automatic switching to a redundant system is not performed, no alarm is issued to the operator, and it is difficult to recognize that a malfunction occurs) occurs, a failure period is extended, and in an Ethernet network, a loop may be generated to cause packet congestion.

FIG. 12 and FIG. 13 are views showing a network failure caused by a loop. A network 50 includes nodes 51 to 54. The nodes 51 to 54 are connected in a ring manner, and the nodes 51 and 54 are connected to each other (in FIGS. 12 and 13, the thin solid lines indicate physical channels).

A tree-structure path is formed in an Ethernet network so as not to generate a loop-shaped path. This is because, if a loop-shaped path is formed in the network, packet congestion called a broadcast storm occurs when a packet is broadcast.

More specifically, when a node sends a broadcast packet, all paths connected to the node are flooded with the broadcast packet from all ports of each node except a receiving port. If there is a loop in the network, the broadcast packet would run in the loop eternally. The packet moves on the same path.

Then, the bandwidth of the network is filled with the broadcast packet immediately, disabling usual communications. As shown in FIG. 12, for example, since the network 50 has a loop R (indicated by a thick solid line), a broadcast packet runs on the loop R from the node 51 to the node 52, to the node 53, to the node 54, and then again, to the node 51, to the node 52, . . . eternally, causing congestion.

Therefore, it is necessary to logically cut off a loop in a layer-2 Ethernet network. As shown in FIG. 13, for example, when channels L1 and L2 are logically cut off, there is no loop and a tree T structure is formed.

To form such a tree (called a spanning tree), control information called a bridge protocol data unit (BPDU) is exchanged between nodes under the control of spanning tree protocol (STP), for example, to perform an operation in which a traffic path is dynamically changed (to perform an operation statically, a tree channel is set in advance for each node). With this, even in a network having a physical loop, a packet is prevented from running in the loop eternally.

Even when a spanning tree is formed as shown in FIG. 13, if a silent failure occurs in the network 50 and a failure detection function does not work effectively, each node may have a different path recognition to break a tree structure and to generate a loop. Therefore, in addition to providing a redundant structure, it is important to detect a silent failure at a high precision.

A conventional technology has been proposed for executing a loop back test at an apparatus in a LAN to detect an Ethernet failure, as in paragraph numbers [0020] to [0027] and FIG. 1 of Japanese Unexamined Patent Application Publication No. 2003-304264.

If a silent failure occurs as described above, only a complaint from the customer serves as a chance to switch from the operation system to a redundant system. Otherwise, the service is not available for a long period of time. Therefore, each vendor has tried to detect a network failure by a unique protocol.

FIG. 14 shows a flow of network-failure detection. It is an example operation for detecting a general network failure with the use of a vendor-unique protocol. Nodes A and B are connected to each other by links L30 and L40.

Step S21: The node A sends a packet Fa to the node B through the link L30 in response to a packet Fb previously received from the node B. Every such packet has a local-node identification field to indicate the sending node and a remote-node identification field to indicate the receiving node. The node A, as the sending node, inserts its own identifier “A” into the local-node identification field of the outgoing packet Fa. To the remote-node identification field of Fa, the node A inserts an identifier “B” by copying the value from the local-node identification field of the packet Eb received through the link L40.

Step S22: Upon receipt of the packet Fa from the node A, the node B transmits another packet Fb over the link L40, placing its own identifier “B” to the local-node identification field of Eb and copying “A” from the local-node identification field of the received packet Fa to the remote-node identification field of the outgoing packet Fb. In this way, two nodes A and B send packets back and forth in steps S21 and S22.

Step S23: Each time the node A receives a packet Fb, the node A saves “B”, the local-node identification field value of Fb, in a memory (in other words, the node A stores information indicating that the remote node is the node B). It is assumed that the aging time (update time when the memory is cleared) of the memory is one minute, and the transmission interval of packets Fb is 20 seconds.

Step S24: Each time the node B receives a packet Fa, the node B stores “A”, the local-node identification field value of Fa, in a memory (in other words, the node B stores information indicating that the remote node is the node A), in the same way as in step S23. It is assumed that the aging time of the memory is one minute, and the transmission interval of packets Fa is 20 seconds.

Step S25: If the node A receives no packet Fb at three consecutive periods, then the node A clears the memory, generates a packet Fa-1 where “0” is inserted into the remote-node identification field, and sends the packet Fa-1 to the node B. The node A also recognizes that a failure has occurred in the link L40 (or the opposite node B) when the node A receives no packet Fb at three consecutive periods.

Step S26: When the node B receives the packet Fa-1, the node B recognizes that “0” has been inserted into the remote-node identification field. More specifically, the node B recognizes that the local-node identifier (B) has not been transmitted to the node A, and the packet Fb which the node B sent has not been correctly received by the node A, and also recognizes that a failure has occurred in the link L40 (or the opposite node A).

In this way, failure detection can be performed between nodes by checking whether “a control packet has not been received for a certain period of time from the opposite apparatus” and whether “response information in a control packet received from the opposite apparatus differs from information transmitted by the local apparatus”.

Since the current network-failure detection which uses a vendor-unique protocol requires control with the monitoring contents of the opposite apparatus being taken into account, as described above, however, the detection can only apply to links connected between apparatuses made by an identical vendor in a network.

Therefore, it is not convenient for the current multivendor carrier networks to use this network-failure detection. In addition, the standardization of a protocol for detecting a network failure has not yet advanced.

In a multivendor environment, if a network failure is detected without requiring a local apparatus and an opposite apparatus to mutually operate according to an identical protocol and without requiring the opposite apparatus to pay attention to failure monitoring, failure resistance is significantly improved. Such technology is strongly demanded.

### SUMMARY OF THE INVENTION

In view of the foregoing, it is an object of the present invention to provide a communication apparatus which detects a network failure by itself without using any particular protocol to interact with remote apparatuses in a virtual LAN environment.

To accomplish the above object, according to the present invention, there is provided a communication apparatus for use on a virtual local area network (VLAN). This communication apparatus has a group of physical link ports, including first and second ports, for connection of physical links to an opposite apparatus belonging to the VLAN. The communication apparatus also has a tagged packet transmission and receiving section and a failure detection section. The tagged packet transmission and receiving section tagged packet transmission and receiving section transmits an outgoing tagged packet from the first port, as well as receiving an incoming tagged packet arriving at the second port. The failure detection section detects a failure on the VLAN by checking whether the outgoing tagged packet transmitted from the first port can return to the second port through a virtual link that tunnels through the opposite apparatus.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 shows the principle of a communication apparatus according to the present invention.

FIG. 2 is a view showing operations according to a first embodiment.

FIG. 3 is a view showing operations according to a second embodiment.

FIG. 4 is a view showing operations according to a third embodiment.

FIG. 5 is a view showing operations according to the third embodiment.

FIG. 6 is a view showing a failure-detection operation performed when a different tag value is registered at each port in a connection form which uses two physical links.

FIG. 7 is a view showing a failure-detection operation performed when a different tag value is registered at each port in a connection form which uses two link aggregation groups (LA groups).

FIG. 8 is a view showing a failure-detection operation performed when a different tag value is registered at each port in a connection form which uses a common physical link.

FIG. 9 shows the structure of a communication apparatus having a function of the communication apparatus shown in FIG. 1

FIG. 10 shows the format of a tagged packet used for failure-monitoring control.

FIG. 11 shows the state transitions of channel state machines.

FIG. 12 is a view showing a network failure in a loop.

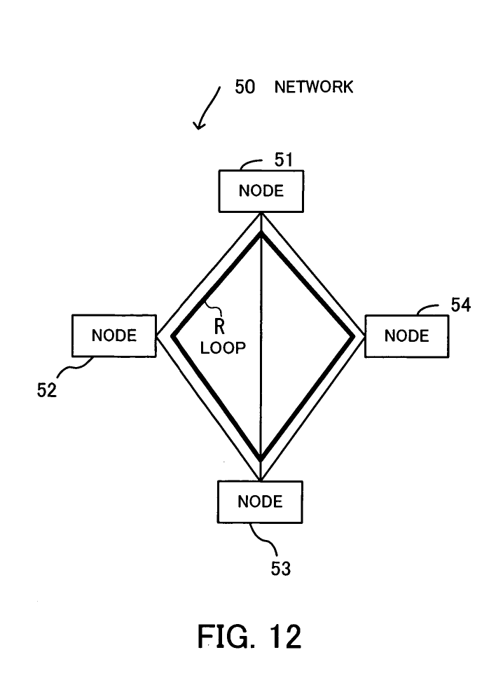

FIG. 13 is a view showing a network failure in a loop.

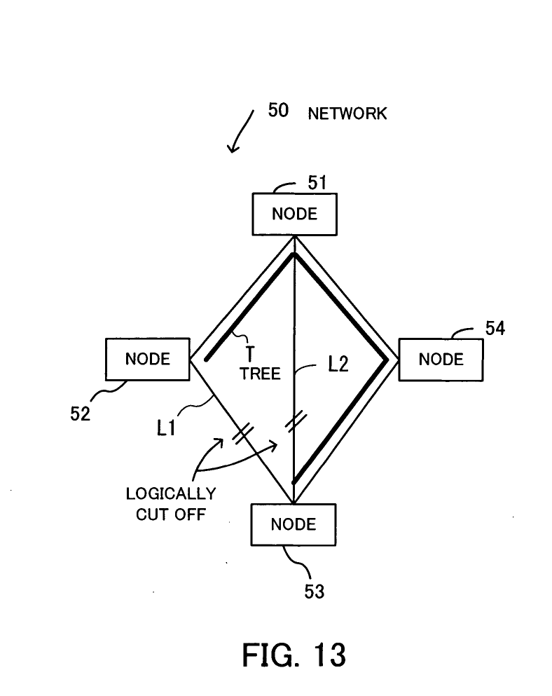

FIG. 14 shows the flow of network failure detection.

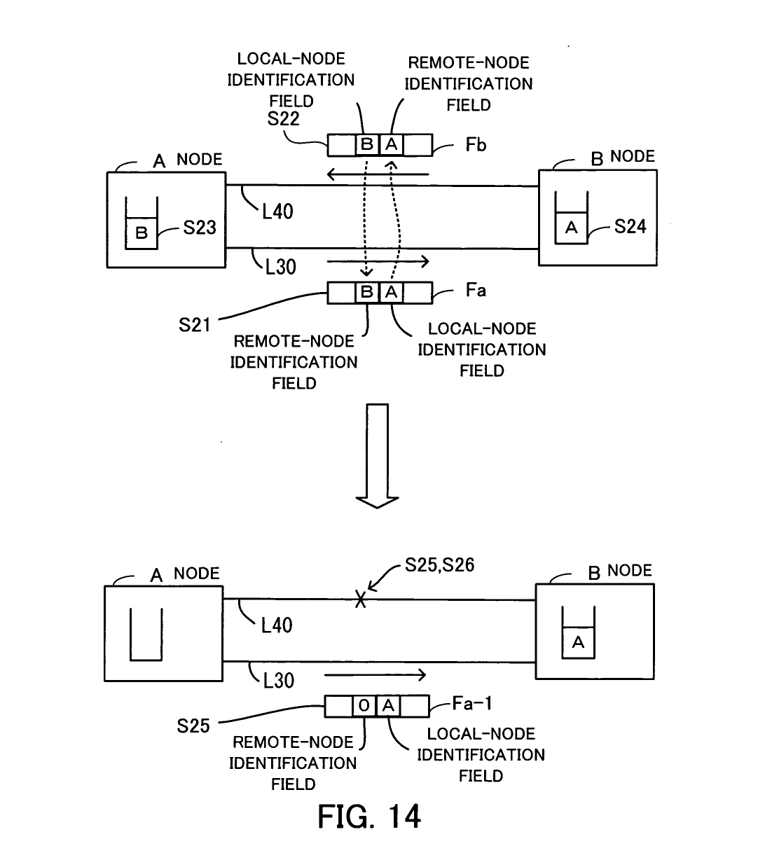

### DESCRIPTION OF THE PREFERRED EMBODIMENTS

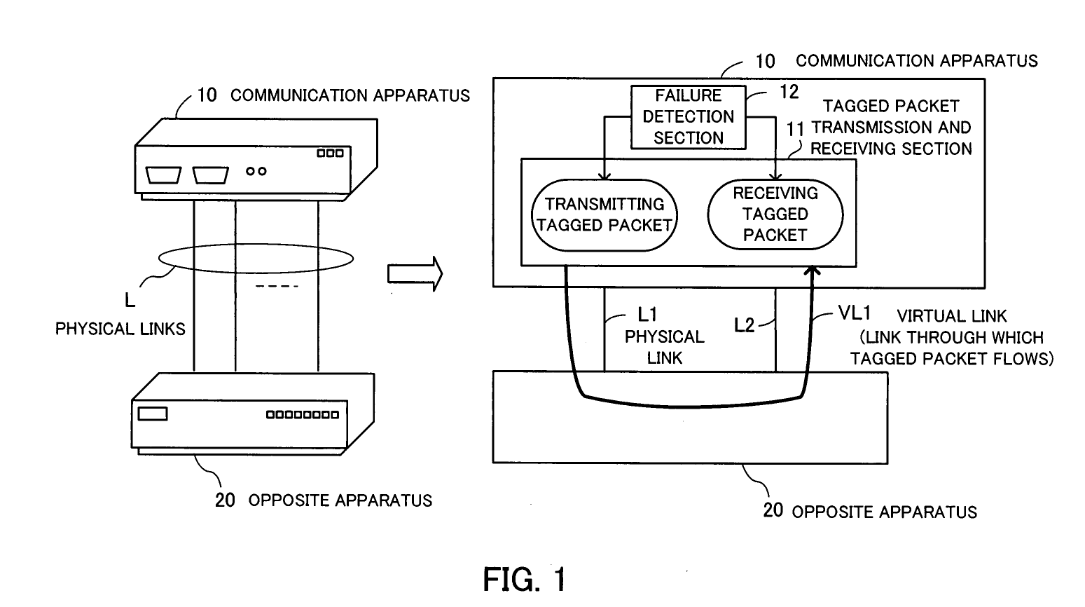

Embodiments of the present invention will be described below by referring to the drawings. FIG. 1 shows the principle of a communication apparatus according to the present invention. A communication apparatus 10 has multiple ports for physical links L, a tagged packet transmission and receiving section 11, and a failure detection section 12, and detects a network failure. The functions of the communication apparatus 10 can be applied, for example, to a layer-2 switch in a wide-area Ethernet.

The communication apparatus 10 and an opposite apparatus 20 both have a virtual LAN (hereinafter called a VLAN) setting function. A VLAN refers to a LAN where terminals connected to a network are virtually (logically) grouped independently of a physical LAN structure. One VLAN serves as one broadcast domain. VLANs are standardized in “IEEE Standards for Local and metropolitan area networks: Virtual Bridged Local Area Networks” (IEEE 802.1Q).

At least two physical links L are used to connect the communication apparatus 10 and the opposite apparatus 20. The opposite apparatus 20 does not need to mutually operate with the communication apparatus 10, which is a local apparatus, under an identical protocol.

The tagged packet transmission and receiving section 11 adds a tag to a packet to generate a tagged packet, and sends the tagged packet to the opposite apparatus 20 through one of the physical links L.

VLAN tagging is specified in IEEE 802.1Q. The value of a tag is registered at a port for a physical link L and is used for identifying the VLAN to which the communication apparatus 10 and the opposite apparatus 20 belong. The tagged packet transmission and receiving section 11 receives the tagged packet which tunnels through the opposite apparatus 20 and is sent from the other of the physical links L.

In FIG. 1, the communication apparatus 10 and the opposite apparatus 20 are connected with two physical links L1 and L2. The tagged packet transmission and receiving section 11 sends a tagged packet through the physical link L1, and receives the tagged packet that has tunneled through the opposite apparatus 20 and been transferred through the physical link L2.

Inside the opposite apparatus 20, a tunneling path has been established between two physical link ports to which the two physical links L1 and L2 are attached. The term “tunneling” means establishing a virtual closed direct communication channel connecting two points. The tunneling path within the opposite apparatus 20, together with the physical links L1 and L2, forms a virtual link VL1, which appears to be a loop-back link from the viewpoint of the communication apparatus 10. When a tagged packet is sent from a port where the set VLAN tag has been registered, the virtual link VL1 transports the packet as if there is a dedicated route like a tunnel between the sending port and receiving port. This link is independent of other communication methods and paths.

To detect a failure on the VLAN, the failure detection section 12 monitors activities at both ends of the virtual link VL1, checking whether each tagged packet transmitted from one end port can return to the other end port of the virtual link VL1.

A basic VLAN operation will be described next, before a detailed operation of the communication apparatus 10 will be described. An apparatus having a VLAN function is provided with a media access control (MAC) table for each tag value serving as a VLAN identifier.

When an apparatus A sends a tagged packet to an apparatus B, the apparatus B searches the MAC table corresponding to the value of the tag attached to the received packet (it is assumed here that the tag value is 100).

The apparatus B uses the MAC table for a tag value of 100 to check whether a destination port corresponding to a destination address (DA) of the received packet has been written in the MAC table. When the destination port has been written in the MAC table, since learning has been finished, the apparatus B outputs the packet from the destination port (port where a tag value of 100 should have been registered).

If the destination port has not been written in the MAC table, since learning has not been finished, the apparatus B floods with the packet from all destination ports where a tag value of 100 has been registered. With such an operation, the packet is sent only from the ports where a tag value of 100 has been registered. A VLAN is established between apparatuses (between communication interfaces) having ports where a tag value of 100 has been registered.

The operation of the communication apparatus 10 will be next described in detail. To make the following description easy to understand, the tagged packet transmission and receiving section 11, which has a transmission and receiving function, is divided into a tagged packet transmission section and a tagged packet receiving section. These two sections will be illustrated as separate elements. A first embodiment will be described in which failure monitoring is performed with two physical links being treated as a pair.

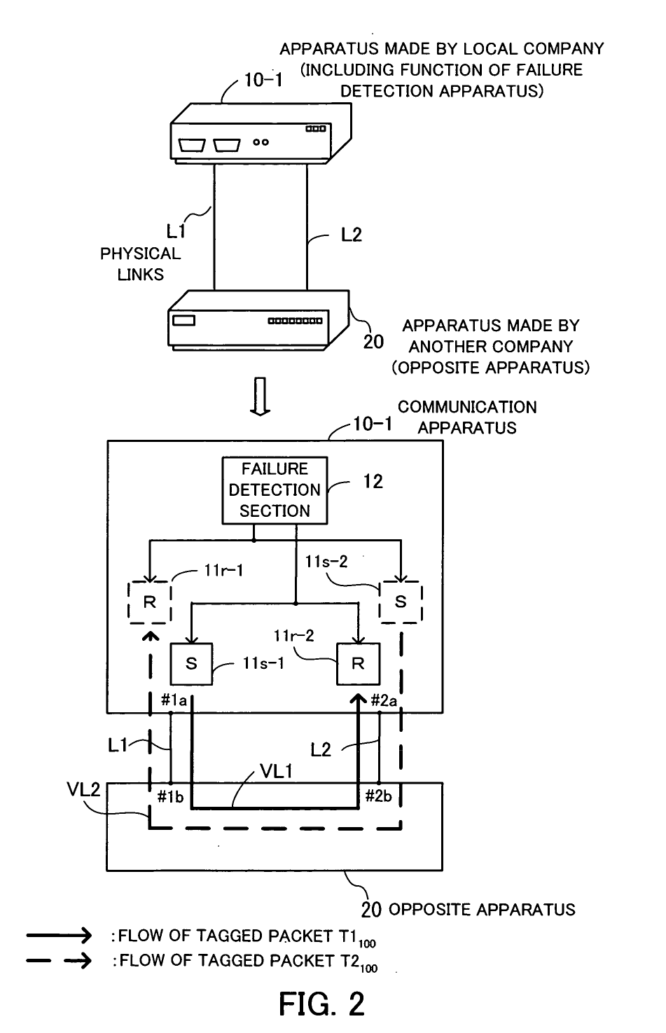

FIG. 2 is a view showing operations according to the first embodiment. A port #1a of a communication apparatus 10-1 and a port #1b of an opposite apparatus 20 are connected with a physical link L1, and a port #2a of the communication apparatus 10-1 and a port #2b of the opposite apparatus 20 are connected with a physical link L2. The physical links L1 and L2 are treated as a pair (the port #la and the port #2a are treated as a pair) and a link state is monitored.

A tag (having a tag value of 100) of a VLAN to be established between the communication apparatus 10-1 and the opposite apparatus 20 are registered in advance at the ports #1b and #2b of the opposite apparatus 20. The apparatus 20 is also set such that, when a packet having the tag is received at the port #1b of the opposite apparatus 20, the packet is transmitted from the port #2b of the opposite apparatus 20 in a transparent manner, and when a packet having the tag is received at the port #2b of the opposite apparatus 20, the packet is transmitted from the port #1b of the opposite apparatus 20 in a transparent manner (these settings are registered in a MAC table of the opposite apparatus 20 in a static manner. This function is a usual function in apparatuses which support IEEE 802.1Q.)

Failure monitoring applied to a flow from the port #1a through the opposite apparatus 20 (tunneling) to the port #2a will be described below. A tagged packet transmission section 11s-1 sends a packet with a tag having a tag value of 100 from the port #1a for the physical link L1 at constant intervals. A packet with a tag having a tag value of 100 and having a DA (MAC DA serving as a multicast address) determined when sent from the port #1a is called a tagged packet T1₁₀₀.

When the opposite apparatus 20 receives the tagged packet T1₁₀₀, the opposite apparatus 20 searches the MAC table corresponding to a tag value of 100 for a destination port corresponding to the DA of the tagged packet T1₁₀₀. Since the destination port corresponding to the DA has been set to the port #2b, the opposite apparatus 20 sends the tagged packet T1₁₀₀ from the port #2b.

A tagged packet receiving section 11r-2 receives the tagged packet T1₁₀₀ at the port #2a for the physical link L2. The failure detection section 12 monitors the ports #1a and #2a at the ends of a virtual link VL1 (or monitors the tagged packet transmission section 11s-1 and the tagged packet receiving section 11r-2) to determine whether the packet T1₁₀₀ sent from the port #1a can tunnel through the opposite apparatus 20 and be received at the port #2a.

Failure monitoring applied to a flow from the port #2a through the opposite apparatus 20 (tunneling) to the port #1a, which is the flow reverse to that described above, will be described below. A tagged packet transmission section 11s-2 sends a packet with a tag having a tag value of 100 (a packet with a tag having a tag value of 100 and having a DA determined when sent from the port #2a is called a tagged packet T2₁₀₀) from the port #2a for the physical link L2 at a constant interval.

When the opposite apparatus 20 receives the tagged packet T2₁₀₀, the opposite apparatus 20 searches the MAC table corresponding to a tag value of 100 for a destination port corresponding to the DA of the tagged packet T2₁₀₀. Since the destination port corresponding to the DA has been set to the port #1b, the opposite apparatus 20 sends the tagged packet T2₁₀₀ from the port #1b.

A tagged packet receiving section 11r-1 receives the tagged packet T2₁₀₀ at the port #1a for the physical link L1. The failure detection section 12 monitors the ports #1a and #2a, which are both ends of a virtual link VL2, (monitors the tagged packet transmission section 11s-2 and the tagged packet receiving section 11r-1) to determine whether the tagged packet T2₁₀₀ sent from the port #2a can tunnel through the opposite apparatus 20 and be received at the port #1a.

When the failure detection section 12 cannot receive a packet at a receiving interval corresponding to the transmission interval through either the virtual link VL1 or the virtual link VL2 or both, the failure detection section 12 regards it as a failure and gives an alarm.

In this way, the communication apparatus 10-1 only needs to check whether a tagged packet used for failure-monitoring control sent from the port #1a can be received at the port #2a, or whether a tagged packet used for failure-monitoring control sent from the port #2a can be received at the port #1a, without checking any internal processing, such as a table search, performed in the opposite apparatus 20. The opposite apparatus 20 simply outputs the tagged packet from a corresponding port according to VLAN setups.

Therefore, it is not necessary to mutually operate the local apparatus and the opposite apparatus under an identical protocol, the opposite apparatus 20 does not need to pay attention to failure monitoring, and a redundant port does not need to be added. A network failure can be efficiently detected in a multi-vendor environment.

A tagged packet will be described here. The tagged packet transmission section specifies in a tagged packet, an identifier indicating that the packet is used for failure monitoring control and the number of a transmission port used to output the packet from the communication apparatus 10, and outputs the packet.

By specifying, in a tagged packet, an identifier indicating that the packet is used for failure monitoring control, whether the tagged packet is a failure monitoring packet or a usual VLAN user data packet can be identified.

By specifying, in a tagged packet, the number of a transmission port for a physical link, used to output the packet, it becomes easier to check the port where the packet was sent in the physical link in an identical VLAN. In FIG. 2, for example, the tagged packet transmission section 11s-1 specifies, in a tagged packet, a port number of #1a and outputs the packet from the port #1a. When the tagged packet receiving section 11r-2 receives the tagged packet, the tagged packet receiving section 11r-2 can understand from the number of the transmission port that the packet was output from the port #1a. (In the case of FIG. 2, since there is only one pair of physical links, even if a transmission-port number is not specified, it is obvious to understand the transmission port. But when three or more physical links are connected, this feature is effective.)

Next, operations of the communication apparatus 10 according to a second embodiment will be described. In the second embodiment, failure detection control is performed when two communication apparatuses from the same or different venders are connected by multiple groups of aggregated links, or “link aggregation groups” (LA groups). The IEEE 802.3ad standard (Link Aggregation Control Protocol) enables a plurality of physical links to be combined into one virtual link for greater redundancy and increased bandwidth. In the following description, a case will be taken in which four physical links are combined into two LA groups, two links in each group.

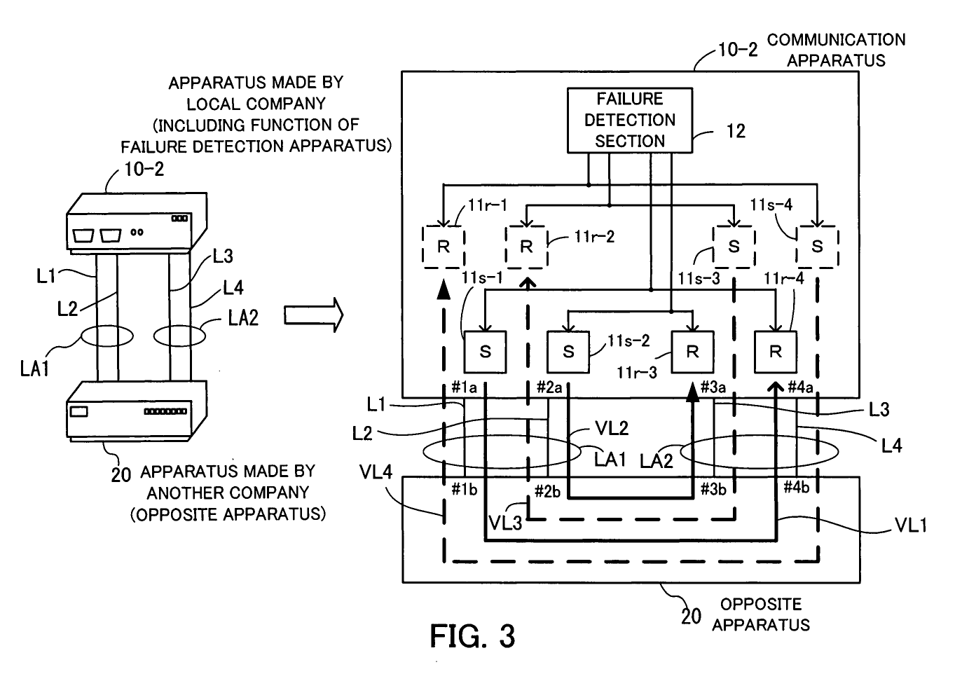

FIG. 3 is a view showing operations according to the second embodiment. A communication apparatus 10-2 and an opposite apparatus 20 are connected by four physical links L1, L2, L3, and L4. The physical link L1 connects a port #1a of the communication apparatus 10-2 and a port #1b of the opposite apparatus 20, the physical link L2 connects a port #2a of the communication apparatus 10-2 and a port #2b of the opposite apparatus 20, the physical link L3 connects a port #3a of the communication apparatus 10-2 and a port #3b of the opposite apparatus 20, and the physical link L4 connects a port #4a of the communication apparatus 10-2 and a port #4b of the opposite apparatus 20.

The physical links L1 and L2 form one LA group (called LA1), and the physical links L3 and L4 form another LA group (called LA2). Failure detection is applied to one pair of LA groups LA1 and LA2. When LA1 and LA2 are used to increase the bandwidth, communications with the use of LA1 and LA2 between the apparatuses are performed, for example, such that user data addressed from the communication apparatus 10-2 to the opposite apparatus 20 is divided and sent through the two physical links L1 and L2 of LA1, and user data in the opposite direction is divided and sent through the other two physical links L3 and L4 of LA2.

It is determined by transmission-port determination algorithm used by the opposite apparatus 20 whether a tagged packet used for failure-detection control sent from the port #1a (or port #2a) of the communication apparatus 10-2 through LA1 is output from the port #3b of the opposite apparatus 20 through LA2 or from the port #4b of the opposite apparatus 20 through LA2. The communication apparatus 10-2 receives it at either the port #3a or the port #4a through LA2.

In general, when a plurality of physical links is treated as one LA group to increase the bandwidth, the sending apparatus usually performs load-distribution control so as to equalize the amount of packets transmitted through each of the plurality of physical links in the LA group. The apparatus applies processing to a packet to be sent, such that a hash calculation is performed with a DA in the packet header used as key information (sometimes, both the DA and SA being used as key information or an IP address being used as such) to obtain a hash value and a destination port corresponding to the hash value is determined. Or alternatively, a fixed transmission port may be used in some apparatuses without performing such a calculation).

Therefore, when the opposite apparatus 20 outputs a packet for failure-detection control to the communication apparatus 10-2 through an LA group, which destination port to use for that packet is dependent on the port determination algorithm implemented in the opposite apparatus 20. Consequently, it is necessary for the communication apparatus 10-2 to recognize the ports to be used for receiving and transmitting failure-detection control packets (i.e., the associations between each receiving port and each transmitting port configured in the opposite apparatus 20), by some operation in advance.

In this case, if a tag value of 100 has been registered at the ports #1b to #4b of the opposite apparatus 20, when the communication apparatus 10-2 sends a packet with a tag having a tag value of 100 from the port #1a through LA1, the communication apparatus 10-2 receives the packet through the port #3b or the port #4b via LA2. The communication apparatus 10-2 needs to recognize the port through which it receives the packet.

One method to determine the receiving port is using a program in the system to perform automatic search to recognize the receiving port. Specifically, the value of the DA (MAC DA serving as a multicast address) in a tagged packet is changed to several values to see the correspondence between the DA and the port, and the receiving port is determined.

For example, the MAC DA, serving as a multicast address, of a tagged packet having a tag value of 100 is changed to 01:00:0e:00:00:01, 01:00:0e:00:00:02, 01:00:0e:00:00:03, and so on (“01” at the top indicates multicast, and “0e” indicates a manufacturer code) and the tagged packet is sent from the port #1a, to see the receiving port, which is either the port #3a or the port #4a, of the tagged packet having a certain DA and the receiving port is determined.

More specifically, when a tagged packet having a DA of 01:00:0e:00:00:02 is sent from the port #1a, if the packet is received at the port #4a, it is recognized that the port #4a is the receiving port (in other words, when a packet for failure-detection control sent from the port #1a is to be received at the port #4a (when the virtual link VL1 is monitored), a DA of 01:00:0e:00:00:02 is set in the packet for failure-detection control). Alternatively, the destination port may be checked off-line and specified in the communication apparatus 10-2 by a command.

Failure monitoring applied to a flow from the port #1a through the opposite apparatus 20 (tunneling) to the port #4a will be described below. It is assumed here that a tag value of 100 of a VLAN to be established between the communication apparatus 10-2 and the opposite apparatus 20 is registered in advance at the ports #1b to #4b of the opposite apparatus 20.

A tagged packet transmission section 11s-1 sends a tagged packet having a tag value of 100 from the port #1a for the physical link L1 at a constant interval. A tagged packet having a tag value of 100 and having a DA determined when sent from the port #1a is called a tagged packet T1₁₀₀.

It has been recognized by the above-described automatic search that the tagged packet T1₁₀₀ can be received at the port #4a (conversely, the tagged packet T1₁₀₀ is a tagged packet having a DA by which the packet can be received at the port #4a).

When the opposite apparatus 20 receives the tagged packet T1₁₀₀, the opposite apparatus 20 performs a hash calculation with the DA and others of the tagged packet T1₁₀₀ being used as key information to determine the port #4b as the destination port, and sends the tagged packet T1₁₀₀ from the port #4b.

A tagged packet receiving section 11r-4 receives the tagged packet T1₁₀₀ at the port #4a for the physical link L4. A failure detection section 12 monitors the ports #1a and #4a, which are both ends of the virtual link VL1, to determine whether the tagged packet T1₁₀₀ sent from the port #1a can tunnel through the opposite apparatus 20 and be received at the port #4a. Failure detection is also applied in the same way to the virtual links VL2 to VL4. Since the same operations are performed also in the virtual links VL2 to VL4, a description thereof is omitted.

When the failure detection section 12 cannot receive a tagged packet at a receiving interval corresponding to the transmission interval at any of the virtual links VL1 to VL4, the failure detection section 12 regards it as a failure and gives an alarm.

As described above, the communication apparatus 10-2 only needs to monitor the port where a tagged packet is sent and a port where the packet is received (only needs to check whether a tagged packet used for failure-monitoring control sent from the port #1a can be received at the port #4a, for the virtual link VL1 (the same control is also performed for the virtual links VL2 to VL4)), without checking any internal processing, such as a hash calculation, performed in the opposite apparatus 20. The opposite apparatus 20 simply outputs the tagged packet from a corresponding port according to the VLAN setups and the implemented transmission algorithm. Therefore, it is not necessary to mutually operate the local apparatus and the opposite apparatus under an identical protocol, the opposite apparatus 20 does not need to pay attention to failure monitoring, and a redundant port does not need to be added. A network failure can be efficiently detected in a multi-vendor environment.

Next, operations of the communication apparatus 10 according to a third embodiment will be described. In the third embodiment, failure detection is performed when one of three or more physical links connecting the communication apparatus 10 and the opposite apparatus 20 is used as a common physical link.

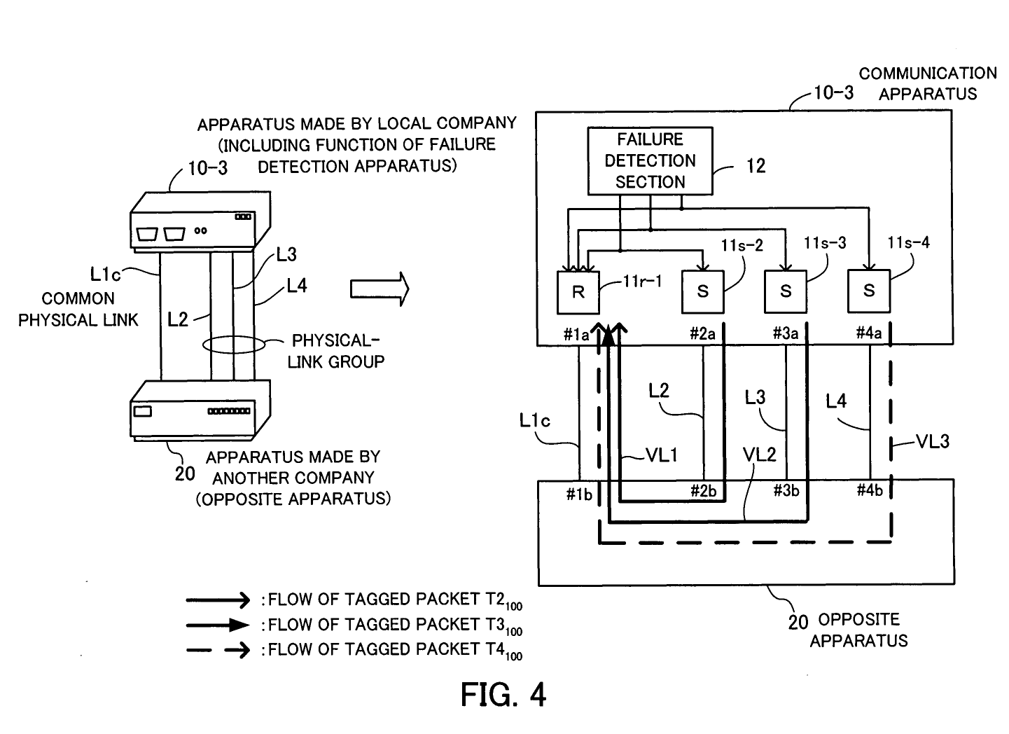

FIG. 4 is a view showing operations according to the third embodiment. A communication apparatus 10-3 and an opposite apparatus 20 are connected by four physical links. Among them, one link serves as a common physical link L1c, and the other links form a group of physical links L2, L3, and L4.

The common physical link L1c connects a port #1a of the communication apparatus 10-3 and a port #1b of the opposite apparatus 20, the physical link L2 connects a port #2a of the communication apparatus 10-3 and a port #2b of the opposite apparatus 20, the physical link L3 connects a port #3a of the communication apparatus 10-3 and a port #3b of the opposite apparatus 20, and the physical link L4 connects a port #4a of the communication apparatus 10-3 and a port #4b of the opposite apparatus 20.

In this type of connections, virtual links VL1, VL2, and VL3 are monitored in which packets flow from the ports #2a, #3a, and #4a through the opposite apparatus 20 (tunneling) to the port #1a, which serves as a common port. It is assumed here that a tag value of 100 has been registered at the ports #1b to #4b of the opposite apparatus 20.

A tagged packet transmission section 11s-2 sends a tagged packet having a tag value of 100 from the port #2a through the physical link L2 at a constant interval. In the same way, tagged packet transmission sections 11s-3 and 11s-4 each send a tagged packet having a tag value of 100 from the ports #3a and #4a through the physical links L3 and L4 at a constant interval. Packets with tags having a tag value of 100 and having DAs determined when sent from the ports #2a, #3a, and #4a are called packets T2₁₀₀, T3₁₀₀, and T4₁₀₀ with tags (the DAs may have an identical value). The tagged packet transmission sections 11s-2 to 11s-4 send the packets T2₁₀₀ to T4₁₀₀ with tags with time differences.

When the opposite apparatus 20 receives the tagged packet T2₁₀₀ the opposite apparatus 20 searches a MAC table corresponding to a tag value of 100 for a destination port corresponding to the DA of the tagged packet T2₁₀₀. Since the destination port corresponding to the DA has been set to the port #1b (as described by referring to FIG. 2, the destination port has been registered in the MAC table in the apparatus 20 in a static manner), the opposite apparatus 20 sends the tagged packet T2₁₀₀ from the port #1b. When the opposite apparatus 20 receives the tagged packet T3₁₀₀ or the tagged packet T4₁₀₀, the opposite apparatus 20 performs the same type of table search and sends the packet from the port #1b.

A tagged packet receiving section 11r-1 receives the tagged packets T2₁₀₀, T3₁₀₀, and T4₁₀₀ at the port #1a through the common physical link L1c with time differences. A failure detection section 12 monitors the ports #1a and #2a, the ports #1a and #3a, and the ports #1a and #4a, which are the ports at both ends of the virtual links VL1 to VL3, respectively, to see whether the tagged packet T2₁₀₀, T3₁₀₀, and T4₁₀₀ sent from the ports #2a, #3a, and #4a, respectively, can tunnel through the opposite apparatus 20 and return to the port #1a.

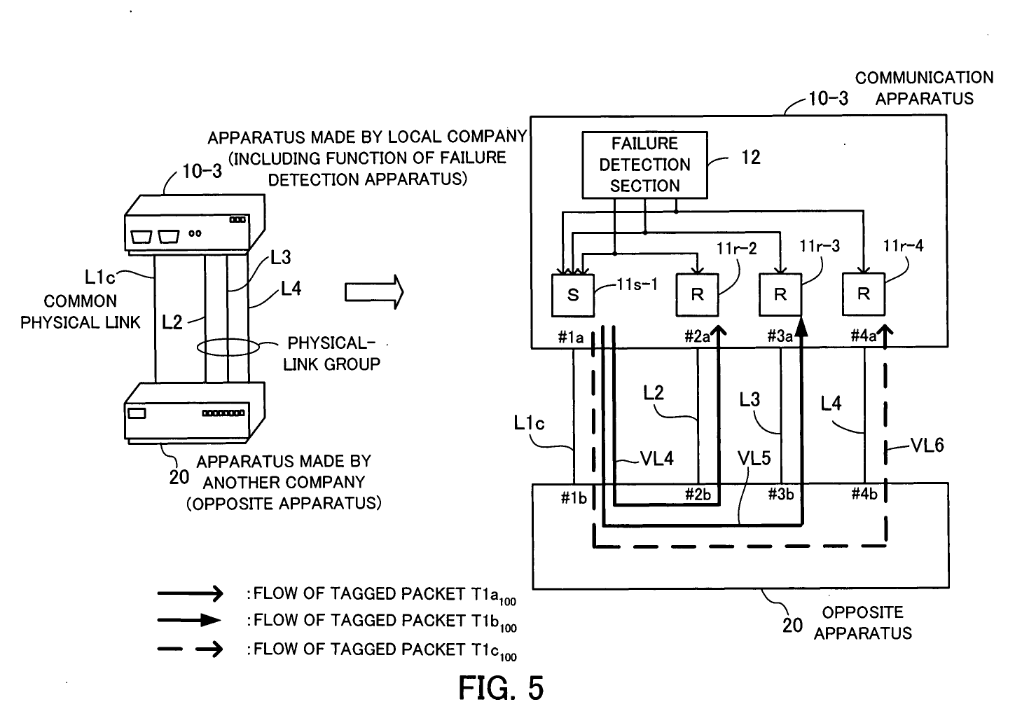

FIG. 5 is a view showing operations according to the third embodiment. FIG. 5 illustrates failure monitoring applied to a flow from the port #1a through the opposite apparatus 20 (tunneling) to the ports #2a, #3a, and #4a.

In this type of connections, it is necessary to check in advance a port where a tagged packet sent from the port #1a can be received among the ports #2a to #4a. Therefore, with methods such as the automatic search for determining a port as described by referring to FIG. 3, it should be checked, for example, that a tagged packet having a tag value of 100 and DA2 can be received at the port #2a, a tagged packet having a tag value of 100 and DA3 can be received at the port #3a, and a tagged packet having a tag value of 100 and DA4 can be received at the port #4a. Packets having a tag value of 100 which can be received at the ports #2a to #4a are called packets T1a₁₀₀, T1b₁₀₀, and T1c₁₀₀ with tags, respectively.

A tagged packet transmission section 11s-1 sends the packets T1a₁₀₀, T1b₁₀₀, and T1c₁₀₀ with tags from the port #1a through the physical link L1c at a constant interval. When the opposite apparatus 20 receives the tagged packet T1a₁₀₀, the opposite apparatus 20 performs a hash calculation with the DA and others of the tagged packet T1a₁₀₀ being used as key information to determine the port #2b as the destination port, and sends the tagged packet T1a₁₀₀ from the port #2b. In the same way, when the opposite apparatus 20 receives the tagged packet T1b₁₀₀ or the tagged packet T1c₁₀₀, the opposite apparatus 20 determines the port #3b or the port #4b as the destination port, and sends the tagged packet T1b₁₀₀ or the tagged packet T1c₁₀₀ from the port #3b or the port #4b.

A tagged packet receiving section 11r-2 receives the tagged packet T1a₁₀₀ at the port #2a through the physical link L2. In the same way, a tagged packet receiving section 11r-3 receives the tagged packet T1b₁₀₀ at the port #3a through the physical link L3, and a tagged packet receiving section 11r-4 receives the tagged packet T1c₁₀₀ at the port #4a through the physical link L4.

A failure detection section 12 monitors the ports #1a and #2a, which are the ports at both ends of the virtual link VL4, to determine whether the tagged packet T1a₁₀₀ sent from the port #1a can tunnel through the opposite apparatus 20 and be received at the port #2a. In the same way, the failure detection section 12 monitors the ports #1a and #3a, which are the ports at both ends of the virtual link VL5, to determine whether the tagged packet T1b₁₀₀ sent from the port #1a can tunnel through the opposite apparatus 20 and be received at the port #3a, and the failure detection section 12 monitors the ports #1a and #4a, which are the ports at both ends of the virtual link VL6, to determine whether the tagged packet T1c₁₀₀ sent from the port #1a can tunnel through the opposite apparatus 20 and be received at the port #4a.

When the failure detection section 12 cannot receive a tagged packet at a receiving interval corresponding to the transmission interval at any of the virtual links VL4 to VL6, the failure detection section 12 regards it as a failure and gives an alarm.

As described above, the communication apparatus 10-3 only needs to monitor the port where a tagged packet is sent and a port where the packet is received, without checking any internal processing, such as the table search and the hash calculation, performed in the opposite apparatus 20. The opposite apparatus 20 simply outputs the tagged packet from a corresponding port according to the VLAN setups and the implemented transmission algorithm. Therefore, it is not necessary to mutually operate the local apparatus and the opposite apparatus under an identical protocol, the opposite apparatus 20 does not need to pay attention to failure monitoring, and a redundant port does not need to be added. A network failure can be efficiently detected in a multi-vendor environment.

In the first to third embodiments, if a failure is detected, an alarm is given to prompt the operator to perform a maintenance operation. Afterwards, the communication apparatuses 10-1 to 10-3 disable the port (the opposite apparatuses 20 detects the disconnection of the link). The disabled port is manually restored, or automatically restored periodically. In addition, a failure detection can be used as a chance to switch to a backup system (e.g., spare links or apparatuses).

Modifications of the first and second embodiments will be described next. In FIG. 2 and FIG. 3, an identical tag value is registered at all the ports of the opposite apparatuses 20, and a DA value attached to a tagged packet sent from the communication apparatuses 10-1 and 10-2 is changed to determine a destination port in the opposite apparatuses 20. In the modifications, a different tag value is registered at each port of an opposite apparatus 20, and a communication apparatus sends and receives packets with tags having an identical DA value and different tag values.

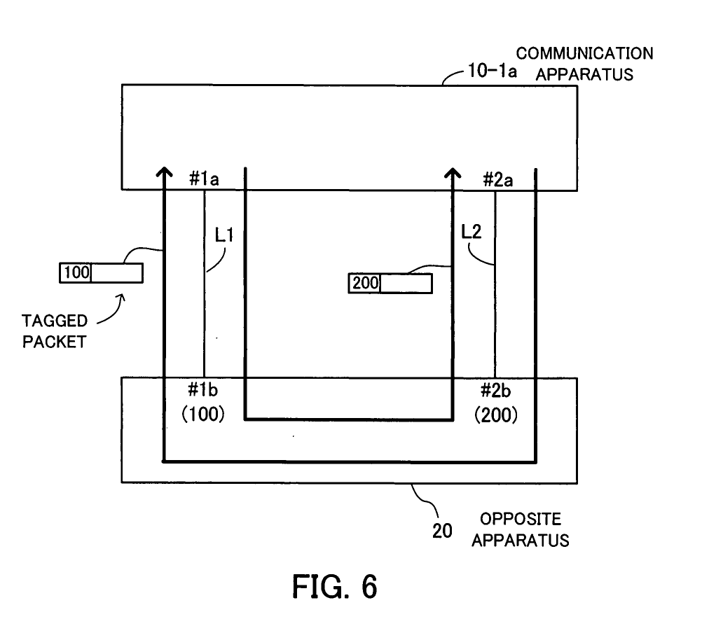

FIG. 6 is a view showing a failure detection operation performed when two physical links are used for connection and a different tag value is registered at each port. FIG. 6 illustrates a modification of the first embodiment, shown in FIG. 2, and shows the same connection structure as FIG. 2.

A tag value of 100 is registered at a port #1b of the opposite apparatus 20, and a tag value of 200 is registered at a port #2b of the opposite apparatus 20. The MAC DA (multicast address) of any tagged packet is set to 01:00:0e:00:00:01.

The opposite apparatus 20 is set such that, when the opposite apparatus 20 receives a tagged packet having a tag value of 100 and a MAC DA of 01:00:0e:00:00:01, the opposite apparatus 20 sends the packet from the port #1b (the port #1b is set as the destination port of the DA (01:00:0e:00:00:01) in the MAC table for a tag value of 100), and when the opposite apparatus 20 receives a tagged packet having a tag value of 200 and a MAC DA of 01:00:0e:00:00:01, the opposite apparatus 20 sends the packet from the port #2b (the port #2b is set as the destination port of the DA (01:00:0e:00:00:01) in the MAC table for a tag value of 200).

A communication apparatus 10-1a sends a tagged packet having a tag value of 200 and a MAC DA of 01:00:0e:00:00:01 from the port #1a, and sends a tagged packet having a tag value of 100 and a MAC DA of 01:00:0e:00:00:01 from the port #2a.

The communication apparatus 10-1a also checks whether the tagged packet having a tag value of 100 and a MAC DA of 01:00:0e:00:00:01 can be received at the port #1a, and checks whether the tagged packet having a tag value of 200 and a MAC DA of 01:00:0e:00:00:01 can be received at the port #2a.

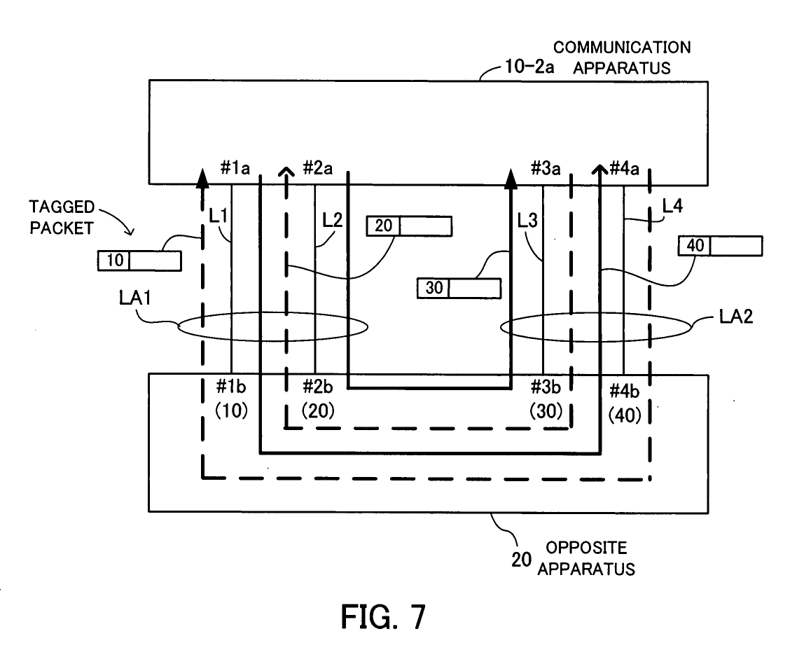

FIG. 7 is a view showing a failure detection operation performed when two pieces of IA are used for connection and a different tag value is registered at each port. FIG. 7 illustrates a modification of the second embodiment, shown in FIG. 3, and shows the same connection structure as FIG. 3. Tag values of 10, 20, 30, and 40 are registered at ports #1b, #2b, #3b, and #4b of an opposite apparatus 20, respectively, and the MAC DA (multicast address) of any tagged packet is set to 01:00:0e:00:00:01.

When the opposite apparatus 20 receives a tagged packet having a tag value of 10 and a MAC DA of 01:00:0e:00:00:01, the opposite apparatus 20 sends the packet from the port #1b through LA1; when the opposite apparatus 20 receives a tagged packet having a tag value of 20 and a MAC DA of 01:00:0e:00:00:01, the opposite apparatus 20 sends the packet from the port #2b through LA1; when the opposite apparatus 20 receives a tagged packet having a tag value of 30 and a MAC DA of 01:00:0e:00:00:01, the opposite apparatus 20 sends the packet from the port #3b through LA2; and when the opposite apparatus 20 receives a tagged packet having a tag value of 40 and a MAC DA of 01:00:0e:00:00:01, the opposite apparatus 20 sends the packet from the port #4b through LA2.

The communication apparatus 10-2a sends a tagged packet having a tag value of 40 and a MAC DA of 01:00:0e:00:00:01 from the port #1a; sends a tagged packet having a tag value of 30 and a MAC DA of 01:00:0e:00:00:01 from the port #2a; sends a tagged packet having a tag value of 20 and a MAC DA of 01:00:0e:00:00:01 from the port #3a; and sends a tagged packet having a tag value of 10 and a MAC DA of 01:00:0e:00:00:01 from the port #4a.

The communication apparatus 10-2a also checks whether the tagged packet having a tag value of 10 and a MAC DA of 01:00:0e:00:00:01 can be received at the port #1a through LA1; checks whether the tagged packet having a tag value of 20 and a MAC DA of 01:00:0e:00:00:01 can be received at the port #2a through LA1; checks whether the tagged packet having a tag value of 30 and a MAC DA of 01:00:0e:00:00:01 can be received at the port #3a through LA2; and checks whether the tagged packet having a tag value of 40 and a MAC DA of 01:00:0e:00:00:01 can be received at the port #4a through LA2.

A modification of the third embodiment will be described next. In FIG. 5, an identical tag value is registered at all the ports of the opposite apparatus 20, and a DA value attached to a tagged packet is changed by the communication apparatus 10-3 to determine a destination port in the opposite apparatus 20. In the modification, a registration tag at each port in an opposite apparatus 20 is appropriately changed, and a communication apparatus uses an identical DA to transmit and receive packets with tags having registered different tag values.

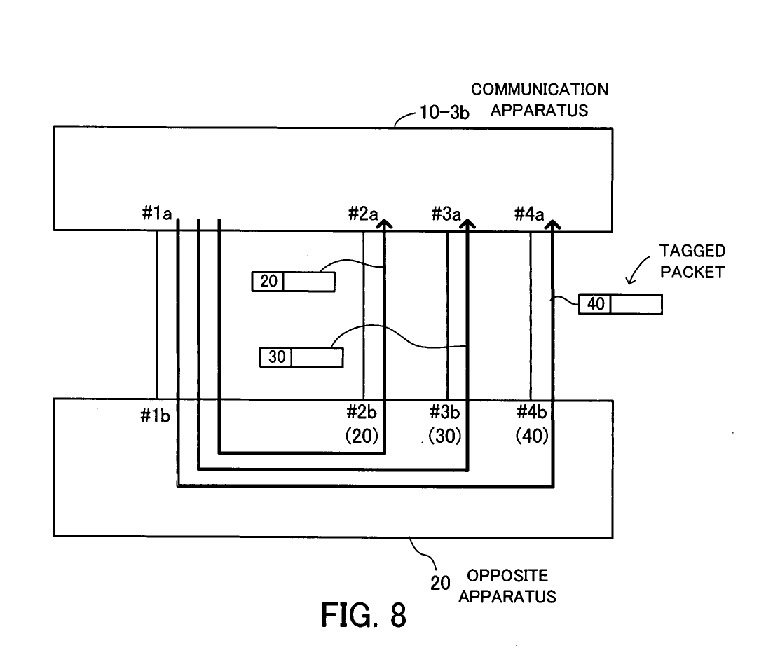

FIG. 8 is a view showing a failure detection operation performed when a common physical link is used for connection and a different tag value is registered at each port. FIG. 8 illustrates a modification of the third embodiment, shown in FIG. 5, and shows the same connection structure as FIG. 5. Tag values of 20, 30, and 40 are registered at ports #2b, #3b, and #4b of the opposite apparatus 20, respectively, and the MAC DA (multicast address) of any tagged packet is set to 01:00:0e:00:00:01.

When the opposite apparatus 20 receives a tagged packet having a tag value of 20 and a MAC DA of 01:00:0e:00:00:01, the opposite apparatus 20 sends the packet from the port #2b; when the opposite apparatus 20 receives a tagged packet having a tag value of 30 and a MAC DA of 01:00:0e:00:00:01, the opposite apparatus 20 sends the packet from the port #3b; and when the opposite apparatus 20 receives a tagged packet having a tag value of 40 and a MAC DA of 01:00:0e:00:00:01, the opposite apparatus 20 sends the packet from the port #4b.

A communication apparatus 10-3b sends packets with tags having tag values of 20, 30, and 40 and a MAC DA of 01:00:0e:00:00:01 from the port #1a sequentially. The communication apparatus 10-3b also checks whether the tagged packet having a tag value of 20 and a MAC DA of 01:00:0e:00:00:01 can be received at the port #2a; checks whether the tagged packet having a tag value of 30 and a MAC DA of 01:00:0e:00:00:01 can be received at the port #3a; and checks whether the tagged packet having a tag value of 40 and a MAC DA of 01:00:0e:00:00:01 can be received at the port #4a.

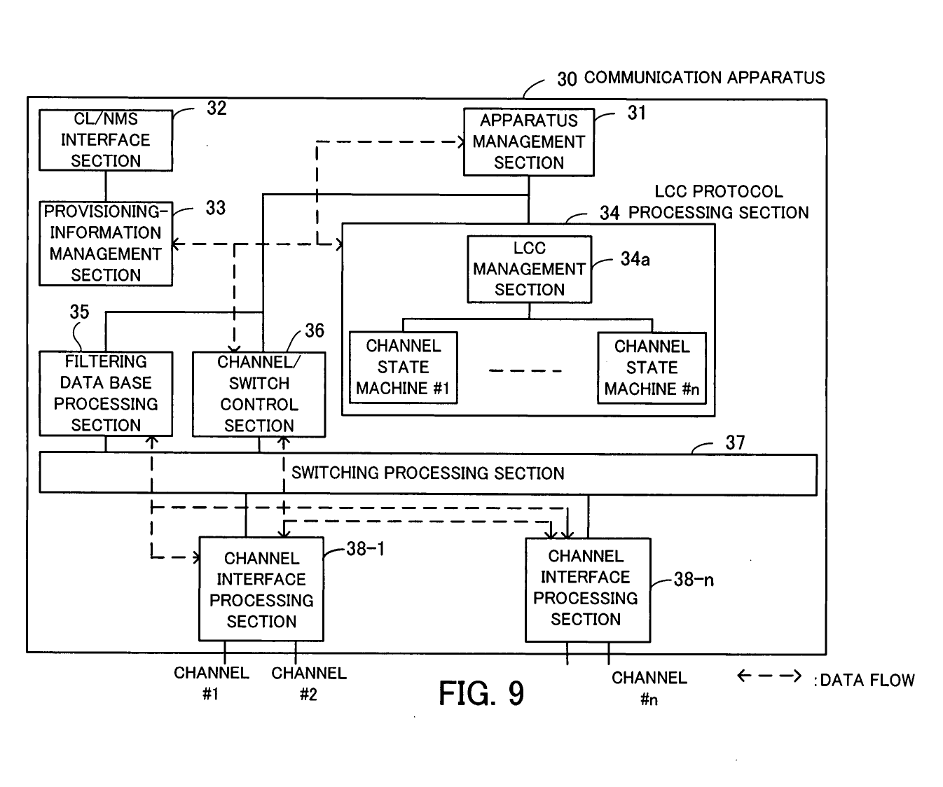

A structure and operation obtained when the communication apparatus 10 is specifically implemented will be described next. FIG. 9 is a view showing the structure of a communication apparatus 30 which has the functions of the communication apparatus 10. The communication apparatus 30 includes an apparatus management section 31, a command-line (CL)/network-management-system (NMS) interface section 32, a provisioning-information management section 33, a link connectivity check (LCC) protocol processing section 34, a filtering data base processing section 35, a channel/switch control section 36, a switching processing section 37, and channel interface processing sections 38-1 to 38-n. The tagged packet transmission and receiving section 11 and the failure detection section 12 are included in the LCC protocol processing section 34.

The apparatus management section 31 manages the whole apparatus. More specifically, the apparatus management section 31 cooperates with the provisioning-information management section 33 to give operation conditions to the switching processing section 37, the channel interface processing sections 38-1 to 38-n, and the LCC protocol processing section 34, based on provisioning information of the apparatus.

The apparatus management section 31 also obtains information related to an operation state, failure occurrence, failure restoration, and others from the switching processing section 37, the channel interface processing sections 38-1 to 38-n, or the LCC protocol processing section 34, and takes necessary action. The function of the apparatus management section 31 can be extended in the following A1 to A4 ways.

A1: The apparatus management section 31 cooperates with the provisioning-information management section 33 to read adminStatus-parameter setting information for each port, and, based on that information, specifies an operation condition for the LCC protocol processing section 34.

A2: The apparatus management section 31 reports failure detection to the operator in response to a notice from the LCC protocol processing section 34.

A3: The apparatus management section 31 knows failure detection by a notice from the LCC protocol processing section 34, and instructs, if necessary, the filtering data base processing section 35 to flash a filtering data base.

A4: The apparatus management section 31 knows failure detection by a notice from the LCC protocol processing section 34, and instructs, if necessary, the channel interface processing sections 38-1 to 38-n to make a transition to a disable state, through the channel/switch control section 36.

The CL/NMS interface section 32 controls the interface between the CL (command line) and the NMS (network management system), and cooperates with the provisioning-information management section 33 to set and display management information.

The provisioning-information management section 33 sets and displays provisioning information, and provides the provisioning information in a manner in which each function block can refer to the information, under the instruction of the CL/NMS interface section 32.

The LCC protocol processing section 34 performs LCC, and, under the operation condition specified by the apparatus management section 31, when the LCC protocol processing section 34 detects a failure, the LCC protocol processing section 34 reports the failure to the apparatus management section 31. The function of the LCC protocol processing section 34 can be extended in the following B1 to B5 ways.

B1: The LCC protocol processing section 34 enables and disables a failure monitoring function and a control-packet transmission function for each port according to an instruction from the apparatus management section 31.

B2: When the control-packet (tagged packet for failure-monitoring control) transmission function is enabled, the LCC protocol processing section 34 instructs, if necessary, that a control packet for failure-monitoring control is sent from each port at an interval instructed by the apparatus management section 31.

B3: When the failure monitoring function is enabled, the LCC protocol processing section 34 monitors receiving of a control packet at each port.

B4: The LCC protocol processing section 34 recognizes a failure when a receiving-monitoring timer for a control packet finishes counting, and reports to the apparatus management section 31 that the corresponding port is in a failure.

B5: The LCC protocol processing section 34 instructs, under the instruction of the apparatus management section 31, the channel interface processing sections 38-1 to 38-n to make a transition to a disable state, through the channel/switch control section 36.

The filtering data base processing section 35 cooperates with the provisioning-information management section 33, the apparatus management section 31, and the channel interface processing sections 38-1 to 38-n to manage the original of a MAC filtering data base to provide each channel interface processing section with a necessary MAC filtering data base and instructs the switching processing section 37 on necessary switching.

The channel/switch control section 36 reports operation conditions to the switching processing section 37 and the channel interface processing section 38-1 to 38-n, and reports to the apparatus management section 31 information related to an operation condition, failure occurrence, failure restoration, and others sent from the switching processing section 37 and the channel interface processing sections 38-1 to 38-n, under the instructions of the apparatus management section 31.

The switching processing section 37 performs switching at each channel interface processing section and a necessary function block in the apparatus under the instruction of the channel/switch control section 36.

The channel interface processing sections 38-1 to 38-n refer to the MAC filtering data base to send and receive a packet under the instruction of the channel/switch control section 36.

Next, failure-detection operation settings in the communication apparatus 30 will be described.

(1) The following operation items are independently specified for a single physical port.

Item 1: Sending a control packet to which a specific VAN and MAC DA. (multicast address/unicast address of an opposite apparatus) are attached, at a specific transmission interval.

Item 2: Monitoring receiving of a control packet to which a specific VAN and MAC DA (multicast address/unicast address of an opposite apparatus) are attached, and determining a failure when the packet is not received for a predetermined period.

(2) Control-packet transmission timing “When the physical port of a concerned port is in an up state” and “when transmission of a control packet for link-connectivity-check monitoring is specified at the concerned port”.

(3) Control-packet receiving monitoring timing

“When receiving monitoring of a control packet for link-connectivity-check monitoring is specified at the concerned port” and “when the concerned port is receiving a control packet”.

A failure is detected when the receiving monitoring timer finishes counting, (a failure-detection trap is sent (an alarm is given when the failure is detected, to prompt a maintenance operation,) and then receiving monitoring is stopped. While receiving monitoring is stopped, when a control packet is received, (a failure restoration trap is sent, and) receiving monitoring is restarted.

If a link disconnection continues for a period longer than the receiving-monitoring timer period, both a link-disconnection trap and a link-connectivity-check-failure trap occur. When the link is restored, both a link-restoration trap and a link-connectivity-check restoration trap are given.

(4) Information required for the operation in control parameters (at a transmission port) VLAN value (including user priority) to be attached, destination MAC address, control-packet transmission interval (fixed), transmission-port ID (sent by a control packet)

(5) Information required for the operation in control parameters (at a receiving monitoring port) VLAN value (to be monitored) to be attached, destination MAC address (to be monitored), receiving monitoring timer (continuous packet-not-receiving period (fixed) by which a failure is determined), transmission-port ID (sent by a control packet)

(6) Notices to a maintenance person

The following items are included.

Item 1: A monitoring start is reported by a trap (“a transmission port” is reported as additional information).

Item 2: A failure detection is reported by a trap (“a failure-detection port” and “a transmission port” are reported as additional information).

Item 3: Failure restoration is reported by a trap (“a restoration detection port” and “a transmission port” are reported as additional information).

Item 4: A setting state related to the link connectivity check function is made to be able to be referred to, by a command.

Item 5: The state of a receiving monitoring port is made to be able to be referred to, by a command. The port state is “not monitored (packet not received)”, “normal” or “defective”. “A transmission port (in the control packet)” and “a shutdown designation port” are reported as additional information.

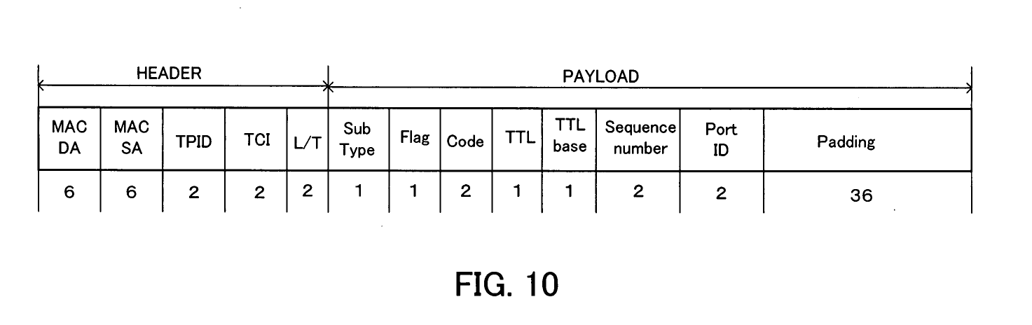

The format of a tagged packet used for failure-monitoring control will be described next. FIG. 10 is a view showing the format of a tagged packet used for failure-monitoring control. In FIG. 10, each numeral indicates the number of bytes. Each field will be described below.

A MAC DA field (6 bytes) indicates a destination MAC address. An address specified by a command is specified in the field. The default is 01-00-0e-00-00-01. A MAC SA field (6 bytes) indicates a transmission-source MAC address. The MAC address of the local apparatus is specified in the field.

A tag protocol identifier (TPID) field (2 bytes) follows the Ether-type setting of the port. A tag control information (TCI) field (2 bytes) is formed of a user priority (3 bits), a canonical format indicator (1 bit), and a VLAN ID (12 bits). A value specified by a command is specified in the user priority (default: 6), the canonical format indicator is fixed to zero, and an address specified by a command is specified in the VLAN ID.

An L/T field (2 bytes) indicates the Ether type of the failure-monitoring-control packet. A value specified by a command is specified in the field (default: FF-F2). A sub type field (1 byte) is fixed to 0x20 (identifier indicating the failure-monitoring-control packet).

A flag field (1 byte) is fixed to zero. A code field (2 bytes) are set to 02-00, and indicates an LCC-function control packet. A time to live (TTL) field (1 byte) is reserved (fixed to 255). A TTL base field (1 byte) is reserved (fixed to 255).

A sequence number field (2 bytes) is fixed to zero. A port ID field (2 bytes) indicates the port identifier of the port where the packet is transmitted. A padding field (36 types) are all set to zero.

A transmission-port/receiving-port processing procedure and a filtering condition will be described next. When a transmission port is in a link up state, and the operation of unidirectional-link-disconnection monitoring is designated to “transmit and receive” or “transmit only”, a control packet is transmitted at a specified interval.

The following six items are performed at the receiving port.

Item 1: When the receiving port is in a link up state, and the operation of unidirectional-link-disconnection monitoring is designated to “transmit and receive” or “receive only”, receiving a packet in a specified period is monitored.

Item 2: Monitoring starts in response to a control packet received at the receiving port. The transmission port ID in the packet is stored.

Item 3: The receiving monitoring timer is reset when the control packet is received.

Item 4: Each time a packet is received, the transmission port ID in the packet is checked. When the ID is changed, the ID is stored.

Item 5: When the receiving monitoring timer finishes counting, it is reported by a trap (additional information: detection port and transmission port).

Item 6: Packet receiving is monitored even in a failure. When a packet is received, the restoration is reported by a trap (additional information: detection port, transmission port).

The filtering condition allows a control packet having a specified tag value and a specified MAC DA (multicast address or local-apparatus unicast address) to be received.

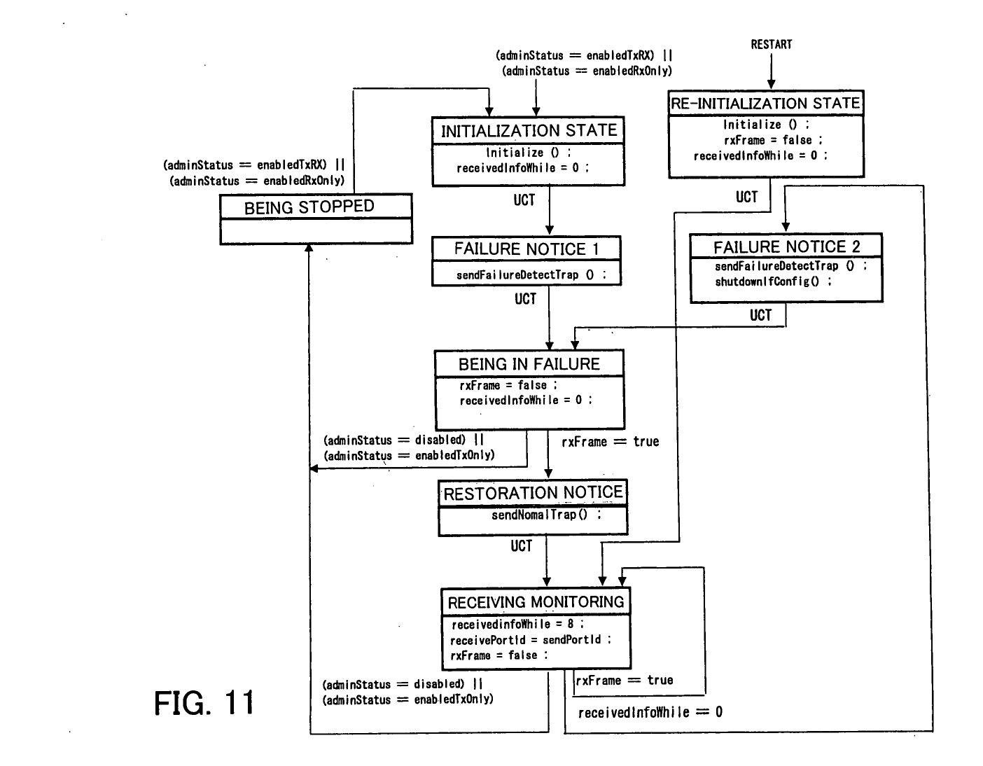

The receiving-monitoring state machine of the communication apparatus 30 will be described next. FIG. 11 is a view showing state transitions of channel state machines #1 to #n. Variables are defined below. UCT indicates unconditional transition, and “restart” is a trigger generated when the CPU is switched or when the software is upgraded.

adminStatus: Setting status of the link connectivity check function at a port concerned. One of “disabled”, “Txonly”, “Rxonly”, and “TX&Rx”.

rxFrame: Indicates whether a monitoring packet has been received at the port. Set to “true” when a monitoring packet is received, and changed to “false” when processing applied to the packet is completed.

receivedInfoWhile: Packet-receiving-monitoring timer variable. A timer value is specified therein when monitoring starts or when a packet is received. This variable is set to zero to stop monitoring. When this variable is not zero, it is reduced at an interval of one second. When it reaches zero, it is used by the timer function, which reports that this variable has reached zero.

receivedPortId: Stores the ID of a transmission port from which a packet being received by the port was transmitted.

sendPortID: Stores the transmission-port ID specified in a received packet.

Functions are defined below.

Initialize ( ): Performs various types of initialization related to the link connectivity check function.

sendKeepaliveStarTrap ( ): Sends a trap indicating that receiving monitoring of link connectivity check has started.

sendFailureDetectTrap ( ): Sends a trap indicating that a failure has been detected by the link connectivity check function.

sendNormalTrap ( ): Sends a trap indicating that a failure detected by the link connectivity check function has been restored.

shutdownIfConfig ( ): Shuts down a specified port when it is specified that the port should be shut down when a failure is detected.

As described above, the communication apparatus 10 can improve failure resistance in a multivendor environment because the communication apparatus 10 eliminates an inconvenience of not being able to detect a failure unless apparatuses made by an identical company are connected by a link, and it allows a network failure to be detected at high precision even if it is connected to an apparatus provided by another vendor. Especially because the communication apparatus 10 does not need any changes in an apparatus provided by another company although the communication apparatus 10 has a unique function, it is easy for a carrier to introduce the communication apparatus 10 in a multivendor environment.

A communication apparatus according to the present invention sends a tagged packet used for identifying a virtual LAN, to an opposite apparatus through one of physical links, and receives the tagged packet transferred through the opposite apparatus and the other of the physical links. To detect a failure, the communication apparatus also checks at both ends of a virtual link through which the tagged packet flows on the physical links whether the tagged packet transmitted passes through the one of the physical links, tunnels through the opposite apparatus, and is received. With this, the local apparatus itself allows a network failure to be detected at high precision in a multivendor environment without mutually operating the local apparatus and the opposite apparatus under an identical protocol.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A communication apparatus for use on a virtual local area network (VLAN), comprising:
a group of physical link ports, including first and second ports, for connection of physical links to an opposite apparatus belonging to the VLAN;
a tagged packet transmission and receiving section for transmitting an outgoing tagged packet from the first port and for receiving an incoming tagged packet arriving at the second port; and
a failure detection section for detecting a failure on the VLAN by checking whether the outgoing tagged packet transmitted from the first port can return to the second port through a virtual link that tunnels through the opposite apparatus.

2. The communication apparatus according to claim 1, wherein the tagged packet transmission and receiving section puts into the outgoing tagged packet an identifier indicating that the outgoing tagged packet is intended for failure monitoring control, and a source port number to indicate from which physical port the outgoing tagged packet is transmitted.

3. The communication apparatus according to claim 1, wherein:
the tagged packet transmission and receiving section transmits another outgoing tagged packet from the second port, while receiving an incoming tagged packet arriving at the first port; and
the failure detection section further checks whether the outgoing tagged packet transmitted from the second port can return to the first port via the opposite apparatus.

4. The communication apparatus according to claim 1, wherein:
the group of physical link ports further includes third and fourth ports; and
the physical links connected to the first and third ports and those connected to the second and fourth ports are logically combined into first and second groups of aggregated links, respectively, by using a link aggregation method.

5. The communication apparatus according to claim 4, wherein:
the tagged packet transmission and receiving section recognizes a plurality of virtual links that run through the first group of aggregated links, the opposite apparatus, and the second group of aggregated links;
the tagged transmission and receiving section transmits outgoing tagged packets to the first group of aggregated links, while receiving incoming tagged packets arriving through the second group of aggregated links; and
the failure detection section detects a falure by checking whether the outgoing tagged packets transmitted to the first group of aggregated links can return through the plurality of virtual links.

6. The communication apparatus according to claim 1, wherein:
the group of physical link ports further includes a third port;
the physical link connected to the second port is assigned as a common link for failure monitoring purposes, while the physical links connected to the first and third ports form a physical link group;
the tagged packet transmission and receiving section recognizes a plurality of virtual links that run through the physical link group to the opposite apparatus and turn back through the common link, transmits an outgoing tagged packet from both the first and third ports; and
the failure detection section detects a falure by checking whether each outgoing tagged packet transmitted from the first and third ports can return to the second port through the plurality of virtual links.

7. The communication apparatus according to claim 1, wherein:
the group of physical link ports further includes a third port;
the physical link connected to the first port is assigned as a common link for failure monitoring purposes, while the physical links connected to the second and third ports form a physical link group;
the tagged packet transmission and receiving section recognizes a plurality of virtual links that run through the common link to the opposite apparatus and turn back through the physical link group, and receives each incoming tagged packet arriving also at the third port; and
the failure detection section detects a falure by checking whether the outgoing tagged packet transmitted from the first port can return to both the second and third ports through the plurality of virtual links.

8. A failure detection method for detecting a failure on a virtual local area network (VLAN) in which a first apparatus and a second apparatus are interconnected by at least first and second physical links, the failure detection method comprising the steps of:
(a) creating a tagged packet by adding a tag for identifying the VLAN to a packet to be transmitted;
(b) transmitting the tagged packet from the first apparatus to the first physical link; and
(c) detecting a failure on the VLAN by checking whether the tagged packet transmitted to the first physical link can return to the first apparatus through the second physical link after tunneling though the second apparatus.

9. The failure detection method according to claim 8, wherein the step (a) puts into the outgoing tagged packet an identifier indicating that the outgoing tagged packet is intended for failure monitoring control, and a source port number to indicate from which physical port the outgoing tagged packet is transmitted.

10. The failure detection method according to claim 8, further comprising the steps of:
transmitting another tagged packet from the first apparatus to the second physical link; and
detecting a failure by checking whether the tagged packet transmitted to the second physical link can return to the first apparatus through the second physical link after tunneling through the second apparatus.

11. The failure detection method according to claim 8, wherein:
the first and second apparatuses are also connected by third and fourth physical links;
the first and third physical links are logically combined into a first group of aggregated links by using a link aggregation method; and
the second and fourth physical links are logically combined into a second group of aggregated links by using the link aggregation method.

12. The failure detection method according to claim 11, further comprising the steps of:
recognizes a plurality of virtual links that run through the first group of aggregated links, the opposite apparatus, and the second group of aggregated links;
transmitting the tagged packet from the first apparatus to the second group of aggregated links; and
detecting a failure by checking whether the tagged packet transmitted to the first group of aggregated links can return to the first apparatus through the plurality of virtual links.

13. The failure detection method according to claim 8, wherein the first and second apparatuses are also connected by a third physical link, the method further comprising the steps of:
assigning the second physical link as a common link for failure monitoring purposes, while forming a physical link group from the first and third physical links;
recognizing a plurality of virtual links that run through the physical link group to the opposite apparatus and turn back through the common link;
transmitting a tagged packet from the first apparatus to the third physical link; and
detecting a failure by checking whether the tagged packets transmitted to the first and third physical links can return to the first apparatus through the plurality of virtual links.

14. The failure detection method according to claim 8, wherein the first and second apparatuses are also connected by a third physical link, the method further comprising the steps of:
assigning the first physical link as a common link for failure monitoring purposes, while forming a group of physical links from the second and third physical links;
recognizing a plurality of virtual links that run through the common link to the second apparatus and turn back through the physical link group; and
detecting a failure by checking whether the tagged packet transmitted to the first physical link can return to the first apparatus through the plurality of virtual links.
